(19) United States
(12) Patent Application Publication
(10) Pub. No.: US 2026/0119113 A1
(43) Pub. Date: Apr. 30, 2026

(54) VISUAL INDICATORS OF IMPROVEMENT ACTIONS PERFORMED DURING A VIRTUAL MEETING

(71) Applicant: Google LLC, Mountain View, CA (US)

(72) Inventors: Felix David Mejia Abreu, Orlando, FL (US); Stéphane Hervé Loïc Hulaud, Stockholm (SE); Carolien Postma, Utrecht (NL); Niklas Blum, Lidingö (SE); Anton Volkov, Seattle, WA (US); Josefin Karlsson, Stockholm (SE); Ahmed Hassan Aly Hassan, Stockholm (SE); Ryan Fedyk, Brooklyn, NY (US)

(21) Appl. No.: 18/931,644

(22) Filed: Oct. 30, 2024

(51) Int. Cl. H04L 12/18; G06F 3/0484

(52) U.S. Cl. CPC G06F 3/165; G06F 3/0484; G06F 9/453; H04L 12/1822

(57) ABSTRACT

Systems and methods for providing visual indicators of improvement actions performed during a virtual meeting. A virtual meeting user interface (UI) is provided for presentation during a virtual meeting for presentation on a user device of a user participating in the virtual meeting. An artificial intelligence (AI)-based action performed to improve audio quality for the user device during the virtual meeting is identified. Upon identifying the AI-based action, the virtual meeting UI of the user device is caused to be modified during the virtual meeting to include a UI feature notifying the user of the AI-based action.

### TECHNICAL FIELD

Aspects and implementations of the present disclosure relate to providing visual indicators of improvement actions performed during a virtual meeting.

### BACKGROUND

Virtual meetings can take place between multiple participants via a virtual meeting platform. A virtual meeting platform can enable users to connect with other users through a video or an audio-based virtual meeting (e.g., a conference call, or a virtual meeting). The virtual meeting platform can provide tools that allow multiple client devices to connect over a network and share each other's audio data (e.g., a voice of a user recorded via a microphone of a client device) and/or video data (e.g., a video captured by a camera of a client device, or video captured from a screen image of the client device) for efficient communication. To this end, the virtual meeting platform can provide a user interface that includes multiple regions to present the audio and/or video streams of each participating client device and multiple UI features present a variety of tools and notifications during the virtual meeting.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In some implementations, a system and method are disclosed for providing visual indicators of AI-based actions during virtual meetings. In an implementation, a method includes providing, for presentation during a virtual meeting, a virtual meeting user interface (UI) for presentation on a user device of a user participating in the virtual meeting. The method includes identifying an AI-based action performed to improve audio quality for the user device of the user during the virtual meeting. The method includes, upon identifying the AI-based action, causing the virtual meeting UI of the user device to be modified during the virtual meeting to include a UI feature notifying the user of the AI-based action.

In some implementations, the method further includes causing the virtual meeting UI of the user device to be modified during the virtual meeting to include a second UI feature to request one of: a confirmation of continuation of the AI-based action or an instruction to stop performing the AI-based action. The method can further include receiving a user input corresponding to the second UI feature. In response to determining that the user input corresponds to the instruction to stop performing the AI-based action, the method can include causing the performance of the AI-based action to stop.

In some implementations, the method can further include determining that the AI-based action partially improved the audio quality for the user device of the user during the virtual meeting. The method can include identifying a second action to further improve the audio quality of the user device during the virtual meeting. In some implementations, in response to determining that the second action satisfies a criterion, the method can include causing the second action be performed. In some implementations, the method can cause the UI feature to notify the user of the second action.

In some implementations, the method can further include providing, as input to an AI model, audio received from the user device during the virtual meeting. The AI model can be trained to output the AI-based action performed to improve the audio quality for the user device of the user during the virtual meeting. The method can include receiving, as output from the AI model, the AI-based action. In some implementations, the AI-based action can be a background noise suppression action and/or an echo removal action.

An aspect of the disclosure provides a system including a memory device and a processing device communicatively coupled to the memory device. The processing device performs the method as described above.

An aspect of the disclosure provides a computer-readable storage medium (which can be a non-transitory computer-readable storage medium, although the disclosure is not limited to that) stores instructions which, when executed, cause a processing device to perform the method as described above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with at least one embodiment of the present disclosure.

FIG. 2 illustrates an example virtual meeting user interface (UI) presented on a client device, in accordance with at least one embodiment of the present disclosure.

FIG. 3 shows an example illustration of a waveform visual indicator notifying a user that an improvement action is being performed to improve the audio quality of the client device, in accordance with at least one embodiment of the present disclosure.

FIGS. 4A-4C show illustrations of examples of a tool panel that includes a UI feature displaying a visual indicator of an improvement action during a virtual meeting, in accordance with at least one embodiment of the present disclosure.

FIG. 5 is a flow diagram of an example method for providing a UI feature notifying the user of an improvement action during a virtual meeting, in accordance with at least one embodiment of the present disclosure.

FIG. 6A illustrates a schematic block diagram for an artificial intelligence (AI) training subsystem of a virtual meeting platform, in accordance with at least one embodiment of the present disclosure.

FIG. 6B illustrates a schematic block diagram for an AI inference subsystem of a virtual meeting platform, in accordance with at least one embodiment of the present disclosure.

FIG. 7 is a block diagram illustrating an exemplary computer system, in accordance with at least one embodiment of the present disclosure.

### DETAILED DESCRIPTION

Aspects of the present disclosure relate to providing visual indicators of improvement actions performed during virtual meetings. A virtual meeting refers to a real-time communication session, such as a virtual meeting call, also known as a video-based call or video chat, in which participants can connect with multiple additional participants, via a virtual meeting platform, in real-time and be provided with audio and video capabilities. A virtual meeting platform can enable video-based virtual meetings between multiple participants via client devices that are connected over a network and share each other's audio (e.g., voice of a user recorded via a microphone of a client device) and/or video streams (e.g., a video captured by a camera of a client device) during a virtual meeting. In some instances, the virtual meeting platform can enable a significant number of client devices (e.g., up to one hundred or more client devices) to be connected via the virtual meeting.

In some instances, the image-based video data can depict a user or a group of users that are participating in the virtual meeting. The audio data can include, in some instances, an audio recording of audio provided by the user or group of users during the virtual meeting. Some existing virtual meeting platforms can provide a virtual meeting user interface (UI) to each client device connected to the virtual meeting, where the virtual meeting UI visually represents the video streams shared over the network in a set of regions in the UI. For example, the video stream of a participant who is speaking to the other participants in the virtual meeting can be visually represented in a designated region in the UI of the virtual meeting platform.

Some virtual meeting platforms can automatically modify the audio and/or video data of the participants'client devices, e.g., using artificial intelligence (AI) models. AI models can be trained to identify improvement actions that can be performed to modify the audio and/or video data of a participant's client device to achieve a better user experience during a virtual meeting. The actions, when performed by the virtual meeting platform, can result in improved quality of audio and/or video data provided to the participants during the virtual meeting. Examples of improved actions include reducing or removing background noise, reducing or removing an echo, improving the lighting of the video, translating speech from one language to another language, ensuring that the video is in focus, etc. Such virtual meeting platforms can perform the improvement actions automatically, in the background, during the virtual meeting, such that participants of the virtual meeting may not be aware that the improvement actions are being performed. Without knowledge of the improvement actions being performed in the background, participants may spend time looking for ways to improve the audio and/or video quality of their respective client devices. For example, a user that has a lot of construction noise in their surrounding physical location may not be aware that the virtual meeting platform is automatically reducing their background noise, and thus may spend time looking for ways to minimize their background noise. The user may investigate settings and features of the virtual meeting platform to find a way to minimize their background noise, which can increase the consumption of computing resources (e.g., processing, computational, and memory resources) used by the virtual meeting platform during the virtual meeting. For example, a user's attempts to rectify a problem that is already being rectified by the virtual meeting platform result in an unnecessary consumption of computing resources, and may affect the performance of the virtual meeting platform. Additionally, by spending time and effort to try to reduce the background noise, the user may be distracted from the meeting. In some instances, the user may be hesitant to participate in the virtual meeting due to the background noise.

In some instances, a user participating in a virtual meeting may not be aware that the audio and/or video quality of their client device is poor. In such instances, the other participants may need to interrupt the meeting to inform a user of the poor audio and/or video quality. The user may attempt to troubleshoot the problem, spending time and computing resources to identify the problem and attempt to resolve the problem. This can cause delays for the participants in the meeting, break the flow of the presentation or discussion, and lead to an unnecessary overconsumption of computing resources.

Aspects of the present disclosure address the above-noted and other deficiencies by providing visual indicators of actions that can improve the audio and/or video quality of a user device of a user participating in a virtual meeting. The virtual meeting platform can provide a virtual meeting user interface (UI) that can include a number of UI features displaying visual indicators. A visual indicator can refer to a graphical element designed to guide, inform, and/or alert the user. A visual indicator can be an animation, and/or can use color, shape, motion, and/or position within the UI to convey information, status, or feedback to the user. In some embodiments, the virtual meeting platform can identify an action performed to improve the audio and/or video quality of a user device participating in the virtual meeting. The improvement action can be, for example, reducing or removing background noise, reducing or removing an echo, improving the lighting of the video feed (e.g., making the video appear brighter or less bright), ensuring that the video is in focus (e.g., not blurry), providing a translation of speech or text from one language to a default language, etc. The virtual meeting platform can notify the user of the identified improvement action using one or more visual indicators.

In some embodiments, the improvement action can be identified by a trained AI model. The AI model can be trained to receive, as input, an audio and/or video feed from a user device during a virtual meeting, and to provide, as output, an indication of an improvement action that can be performed to improve the quality of the audio and/or video feed. In some embodiments, the improvement action can be identified based on a set of rules. The virtual meeting platform can analyze the audio and/or video feed received from a user device, and can identify one or more improvement actions corresponding to the analysis of the audio and/or video feeds.

In some embodiments, once the improvement action has been identified, the virtual meeting platform can update a UI feature to include a visual indicator to notify the user of the identified improvement action. As an illustrative example, the visual indicator can be a visual representation of a waveform that changes color according to the identified improvement action. For example, the default color for the waveform can be green, which can represent good audio quality. Upon identifying an improvement action, the virtual meeting platform can determine whether to change the waveform from green to yellow or red. Yellow can represent an audio quality that is automatically being improved by the virtual meeting platform, and thus the user does not need to take any further action. For example, the improvement action can be a reduction of background noise, which the virtual meeting platform can automatically perform. Once performed, the virtual meeting platform can determine that the resulting audio quality of the user device exceeds a threshold quality, and thus no further action is needed. Thus, a yellow waveform can indicate to the user that there is a problem with the quality of the audio, but that the virtual meeting platform has resolved the problem. Red can represent an audio quality that may require user action or input to improve. For example, the improvement action can be to mute the audio of the client device (e.g., due to an echo). Rather than automatically muting the audio during a virtual meeting, the virtual meeting platform can notify the user that there is an echo and that a user input is required to remove the echo. Thus, the virtual meeting platform can display the waveform in red, and can optionally present additional UI features to help the user provide input to improve the audio quality. For example, when the user hovers their mouse on the red waveform, the virtual meeting platform can present a second UI feature that provides instructions to the user on what input to provide to improve the audio quality.

In some embodiments, the improvement action can be automatically performed by the virtual meeting platform. In some embodiments, the virtual meeting platform can have a list of improvement actions that can be automatically performed, and a list of improvement actions that require user input in order to be performed. In some embodiments, automatically performing the improvement action can depend on a confidence score output by the AI model. The confidence score can reflect a likelihood that performing the improvement action will improve the quality of the audio and/or video. Thus, in some embodiments, the virtual meeting platform can automatically perform the identified improvement action if the corresponding confidence score is above a threshold value. As an illustrative example, the AI model can identify an improvement action to remove or reduce the background noise of a participant, and the improvement action can be on the list of automatically performed actions. Thus, the virtual meeting platform can automatically (without any user input) perform the action. Upon performing the action, the virtual meeting platform can, via the UI, inform the user that the action has been or is being performed. For example, the virtual meeting platform can present a UI feature that notifies the user that background noise has been or is being automatically reduced or removed. In some embodiments, the virtual meeting platform can request the user to confirm performance of the action or stop performance of the action. That is, the virtual meeting platform can update a second UI feature to request either confirmation of continuation of the action or an instruction to stop performing the action. The virtual meeting platform can then proceed according to the user's input (e.g., stop performance of the action if the user provided a corresponding input).

In some embodiments, the virtual meeting platform can determine that the improvement action only partially improved the audio and/or video quality of the virtual meeting. For example, the improvement action may have removed the background noise, but the virtual meeting platform can determine that the quality of the resulting audio with the background noise removed is not satisfactory. The virtual meeting platform can identify a second action to further improve the audio and/or video quality of the user device. The virtual meeting platform can identify the second action using one or more AI models and/or using predefined rules (e.g., as described above). In some embodiments, the virtual meeting platform can provide the resulting audio stream after performing the first improvement action (e.g., with the background noise removed) to an AI model that can provide an additional improvement action. In some embodiments, the virtual meeting platform can analyze the resulting audio stream after performing the first improvement action to identify another improvement action to improve the resulting audio stream. In some embodiments, the virtual meeting platform can notify the user, via the UI, of the second action, and present the user with the option to implement the second action. In some embodiments, the virtual meeting platform can automatically perform the second action. The virtual meeting platform can notify the user of the second action being performed, and optionally present the user with the option to stop performance of the second action.

Advantages of the present disclosure result in a number of technological advantages over previous solutions including, for example, improved performance of the virtual meeting interface and improved overall performance of the virtual meeting platform. In particular, the aspects of the present disclosure provide visual indications of actions performed to improve audio and/or video quality for a particular user, which can result in a more efficient use of processing resources utilized to facilitate the virtual meeting. That is, the virtual meeting platform can automatically perform an improvement action, reducing or eliminating the need for a user to learn about a problem with the quality of the audio and/or video quality of their client device, identify a potential improvement action, and/or attempt to perform an improvement action to improve the quality of the video and/or audio of their client device. The functionality provided by aspects of the present disclosure can avoid the unnecessary consumption of computing resources (e.g., processing, computational, and memory resources) used while a user attempts to improve the audio and/or video quality of their client device that has already been improved by the virtual meeting platform. This computing resource consumption can be particularly wasteful when the virtual meeting platform is automatically performing an improvement action, as described throughout the present disclosure. Aspects of the present disclosure also enhance AI transparency, improve a user's confidence when participating in meetings, alleviate certain pain points associated with virtual meetings, and can reduce a user's action to resolve problems that are already being addressed by AI.

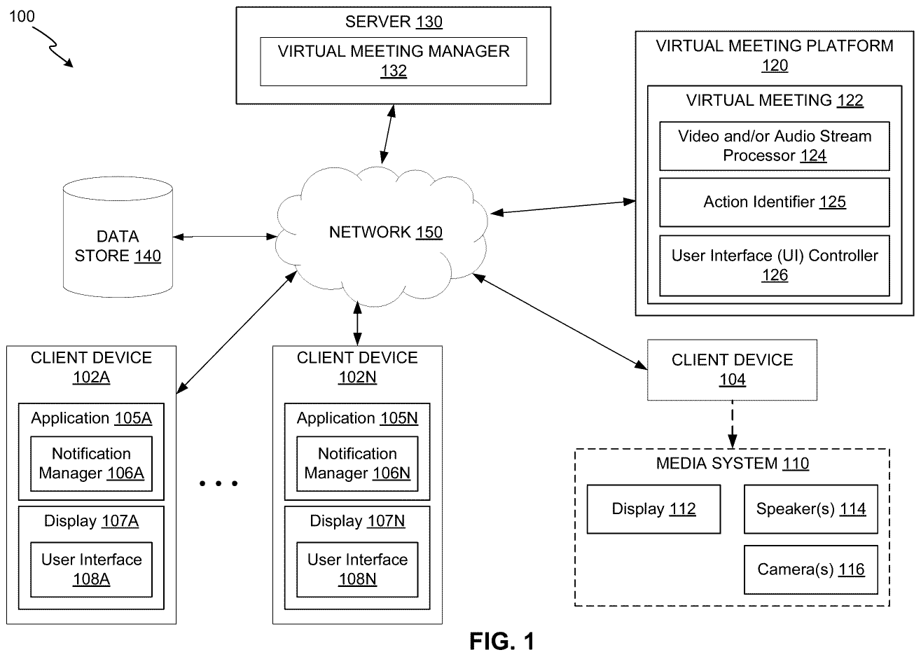

FIG. 1 illustrates an example system architecture 100, in accordance with at least one embodiment of the present disclosure. System architecture 100 (also referred to as “system” herein) includes client devices 102A-102N, one or more client devices 104, virtual meeting platform 120, server 130, and data store 140, each connected to network 150.

In some implementations, network 150 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 140 is a persistent storage that is capable of storing data as well as data structures to tag, organize, and index the data. A data item can include audio data and/or video data, in accordance with implementations described herein. In some embodiments, audio and/or video data can include raw data produced by a microphone and/or camera (e.g., connected to a client device 102A-102N, 104), sometimes referred to as audio and/or video feed. In some embodiments, audio and/or video data can include processed (e.g., encoded) video and/or audio data, sometimes referred to as a audio and/or video streams. For example, the processed audio and/or video can be processed by performing an improvement action, and can be transmitted, e.g., to server 130 and/or to one or more client devices 102A-102N, 104. Data store 140 can be hosted by one or more storage devices, such as main memory, magnetic or optical storage-based disks, tapes or hard drives, NAS, SAN, and so forth. In some implementations, data store 140 can be a network-attached file server, while in other implementations data store 140 can be some other type of persistent storage such as an object-oriented database, a relational database, and so forth, that can be hosted by virtual meeting platform 120 or one or more different machines (e.g., the server 130) coupled to the virtual meeting platform 120 via network 150. In some implementations, data store 140 can store portions of audio and video feeds received from the client devices 102A-102N for the virtual meeting platform 120. Moreover, the data store 140 can store various types of documents, such as a slide presentation, a text document, a spreadsheet, or any suitable electronic document (e.g., an electronic document including text, tables, videos, images, graphs, slides, charts, software programming code, designs, lists, plans, blueprints, maps, etc.). These documents can be shared with users of the client devices 102A-102N, 104, and/or concurrently editable by the users.

Virtual meeting platform 120 can enable users of client devices 102A-102N and/or client device(s) 104 to connect with each other via a virtual meeting (e.g., a virtual meeting 122). A virtual meeting refers to a real-time communication session such as a virtual meeting call, also known as a video-based call or video chat, in which participants can connect with multiple additional participants in real-time and be provided with audio and video capabilities. Real-time communication refers to the ability for users to communicate (e.g., exchange information) instantly without transmission delays and/or with negligible (e.g., milliseconds or microseconds) latency. Virtual meeting platform 120 can allow a user to join and participate in a virtual meeting with other users of the platform. Implementations of the present disclosure can be implemented with any number of participants connecting via the virtual meeting (e.g., up to one hundred or more).

In some implementations, virtual meeting 122 can include a video and/or audio stream processor 124, an action identifier 125, and/or a user interface (UI) controller 126. Video and/or audio stream processor 124 can receive video feeds (e.g., the video stream pertaining to one or more participants of a virtual meeting) and/or audio feeds (e.g., from an audiovisual component of the client device) from the client devices 102A-102N and/or 104. Video and/or audio stream processor 124 can process the audio and/or video, in order to convert the raw audio and/or video feeds received from a client device into a form that can be interpreted by an AI model. In some embodiments, the video and/or audio stream processor 124 can receive raw audio signals and can perform feature extraction to generate audio data that can be interpreted by an AI model. For example, the audio signal can be converted from the time domain into the frequency domain, to create a spectrogram that represents how the energy of the signal is distributed over different frequencies across time. The resulting data can be a spectrogram image, or its numerical array representation, for example. Other feature extraction methods may be used. Video and/or audio stream processor 124 can provide the processed audio data to action identifier 125.

In some embodiments, video and/or audio stream processor 124 can receive a video feed from a client device 102A-102N, 104, and can process the video feed to convert the video feed into a form that can be interpreted by an AI model. For example, the video and/or audio stream processor 124 can perform frame extraction and optical flow analysis. Video and/or audio stream processor 124 can break down the video into individual frames (e.g., according to the frame rate of the video feed). The optical flow analysis can capture motion between frames by analyzing pixel displacement, resulting in an optical flow vector. Video and/or audio stream processor 124 can provide the processed video data (e.g., individual frames or sequences, optionally optical flow vectors) to action identifier 125.

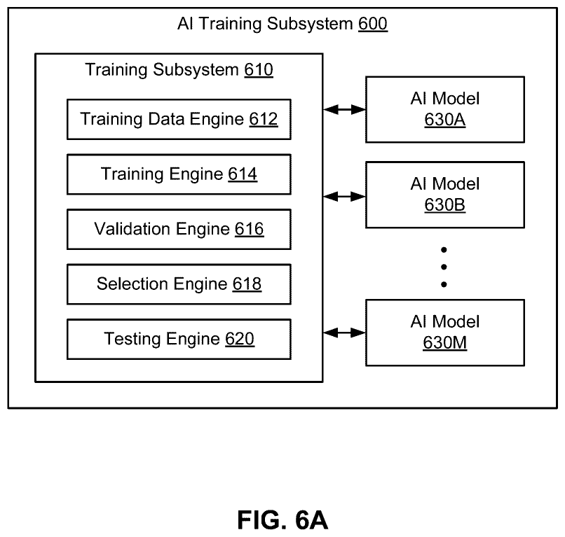

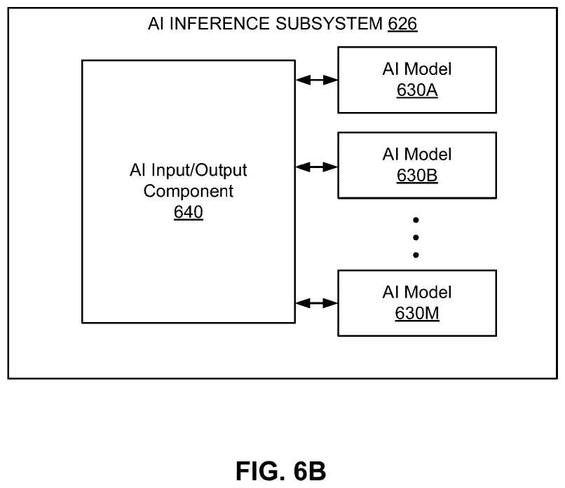

Action identifier 125 can receive (or identify already received) video data and/or audio data pertaining to a client device participating in virtual meeting 122 (e.g., client device 102A-102N or 104). Action identifier 125 can identify one or more actions that can improve the quality of a video data and/or audio data for the client device. In some implementations, action identifier 125 can provide the video data and/or audio data corresponding to a client device 102A-102N or 104 as input to one or more AI models trained to identify action(s) to improve the quality of the corresponding video and/or audio data. The AI model(s) can provide, as output, action(s) to improve the audio and/or video quality of the corresponding client device 102A-102N, 104. The AI model(s) are further described with respect to FIGS. 6A-6B. In some embodiments, the AI model(s) can output a confidence score corresponding to each identified action. The confidence score can reflect a likelihood the performance of the corresponding action will result in an improvement of the audio and/or video quality.

In some embodiments, action identifier 125 can identify one or more improvement actions based on a set of predetermined rules. Action identifier 125 can analyze the video and/or audio data for a client device 102A-102N, 104, and can compare the analyzed data to the predetermined rules to identify an improvement action.

In some embodiments, action identifier 125 can determine to automatically perform the identified improvement action(s). In some implementations, action identifier 125 can reference a list of actions, where the list includes an indicator of whether the action is to be automatically performed or whether the action is to be performed responsive to receiving an instruction from a user (e.g., of client device 120A-102N, 104) to perform the action. In some implementations, action identifier 125 can determine to automatically perform an action that satisfies a particular criterion. For example, the action can correspond to confidence score, and the action identifier 125 can determine to automatically perform the action if the confidence score exceeds a threshold value. In some embodiments, action identifier 125 can notify UI controller 126 of the identified action(s), and whether the action(s) have been automatically performed.

UI controller 126 can provide the UI for a virtual meeting. The UI can include multiple regions and UI features. Each region can display a video stream pertaining to one or more participants of the virtual meeting. Each UI feature can represent a tool or visual indicator provided by the virtual meeting platform 120. For example, in response to being notified of the identified action(s), UI controller 126 can determine which visual indicators to modify to notify the user of the identification action(s). UI controller 126 can transmit a command causing each determined visual indicator to be displayed in a region of the UI and/or rearranged in the UI.

Client devices 102A-102N can each include computing devices such as personal computers (PCs), laptops, mobile phones, smart phones, tablet computers, netbook computers, network-connected televisions, etc. In some implementations, client devices 102A-102N can also be referred to as “user devices. ” Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio feed) based on the captured audio signal. The audiovisual component can include another device (e.g., a speaker) to output audio data to a user associated with a particular client device 102A-102N. In some implementations, the audiovisual component can also include an image capture device (e.g., a camera) to capture images and generate video data (e.g., a video feed) of the captured data of the captured images.

In some implementations, virtual meeting platform 120 is coupled, via network 150, with one or more client devices 104 that are each associated with a physical conference or meeting room. Client device(s) 104 can include or be coupled to a media system 110 that can include one or more display devices 112, one or more speakers 114 and one or more cameras 116. Display device 112 can be, for example, a smart display or a non-smart display (e.g., a display that is not itself configured to connect to network 150). Users that are physically present in the room can use media system 110 rather than their own devices (e.g., client devices 102A-102N) to participate in a virtual meeting, which can include other remote users. For example, the users in the room that participate in the virtual meeting can control the display 112 to show a slide presentation or watch slide presentations of other participants. Sound and/or camera control can similarly be performed. Similar to client devices 102A-102N, client device(s) 104 can generate audio and video data to be streamed to virtual meeting platform 120 (e.g., using one or more microphones, speakers 114 and cameras 116).

Each client device 102A-102N and/or 104 can include client application 105A-N, which can be a mobile application, a desktop application, a web browser, etc. In some implementations, client application 105A-N can present, on a display device 107-107N of client device 102A-102N, a user interface (UI) (e.g., a UI of the UIs 108A-108N) for users to access virtual meeting platform 120. For example, a user of client device 102A can join and participate in a virtual meeting via a UI 108A presented on the display device 107A by client application 105A. A user can also present a document to participants of the virtual meeting via each of the UIs 108A-108N. Each of the UIs 108A-108N can include multiple regions to present visual items corresponding to video streams of the client devices 102A-102N provided to the server 130 for the virtual meeting. Each of the UIs 108A-108N can include multiple UI features corresponding to notifications and/or tools provided by the virtual meeting platform. For example, a UI feature can present a visual indicator notifying the user of an improvement action being performed, as described throughout. Each UI 108A-108N can display the UI features as instructed by UI controller 126.

In some implementations, application 105A-105N can include a notification manager 106A-106N. Notification manager 106A-106N can provide a dynamic and modular notification region for display on UI 108A-N. In some embodiments, the region can be part of a tool panel provided to the user via the UI. In some implementations, the notification manager 106A-106N can display the region in a specific section of user interface 108A-N. For example, the region can be displayed in the top-left corner of user interface 108A-N, the top-right corner of user interface 108A-N, the bottom-left corner of user interface 108A-N, the bottom-right corner of user interface 108A-N, etc.

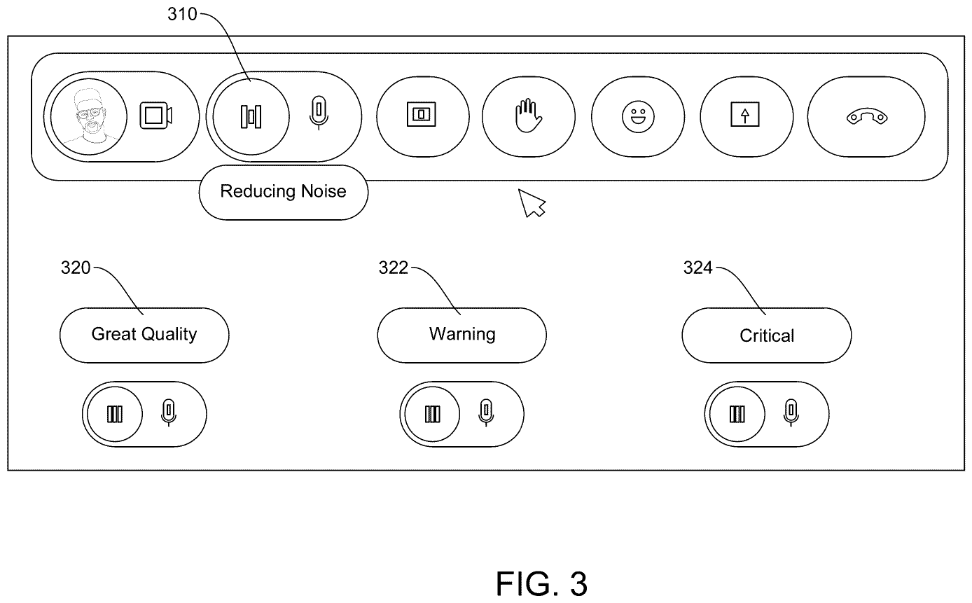

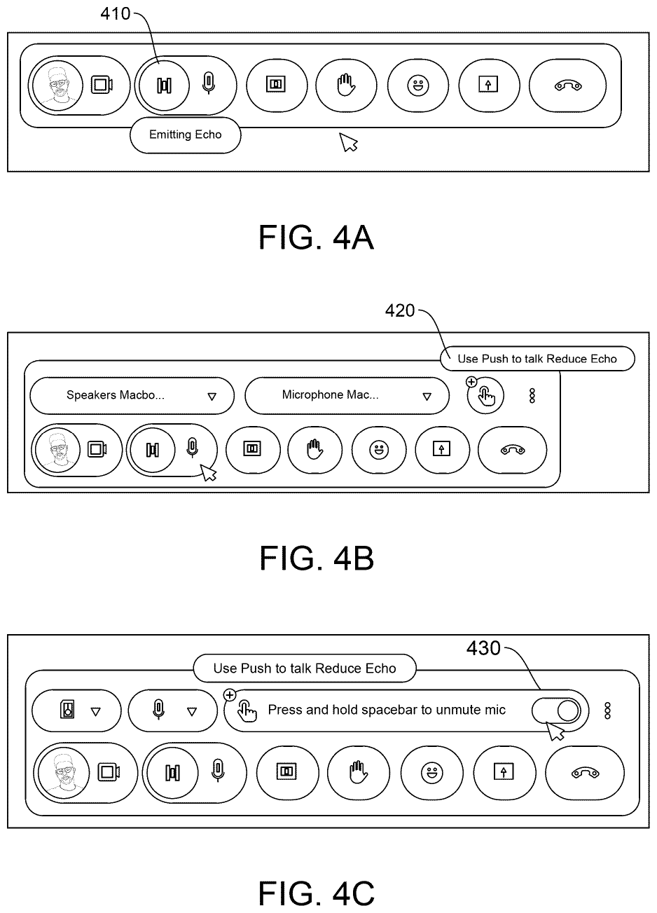

Notification manager 106A-106N can display one or more UI features to display visual indicator(s) of notification(s) related to improvement action(s) identified and/or performed by the virtual meeting platform 120 during the virtual meeting. The improvement actions can include, for example, reducing or removing background noise, removing an echo, adjusting the lighting of the video feed, initiating translation from one language to another, ensuring that the video is in focus, etc.). A visual indicator can refer to a UI element used as a visual aid to convey specific information (e.g., the type of action that performed) and/or to request an instruction from a user (e.g., an instruction to perform an identified improvement action, an instruction to continue or discontinue an improvement action that was automatically performed, etc.) on user interface 108A-108N. When an action is identified and/or performed (e.g., as determined by action identifier 125), notification manager 106A-106N can generate a notification by triggering a modification of the UI to display one or more corresponding visual indicators, or by modifying one or more already displayed visual indicators. Modifying an already displayed visual indicator can include changing the size, shape, and/or color of the visual indicator. For example, to notify the user that an improvement action is being performed to improve the quality of the audio feed, the notification manager 106A-106N can change the color of the waveform illustration from green to red (as is further described with respect to FIGS. 3 and 4A-4C).

In some implementations, server 130 includes a virtual meeting manager 132. Virtual meeting manager 132 can be configured to manage a virtual meeting between multiple users of virtual meeting platform 120. In some implementations, virtual meeting manager 132 can provide the UIs 108A-108N to each client device to enable users to watch and listen to each other during a virtual meeting. Virtual meeting manager 132 can also collect and provide data associated with the virtual meeting to each participant of the virtual meeting. In some implementations, virtual meeting manager 132 can provide the UIs 108A-108N for presentation by client application 105A-105N. For example, the UIs 108A-108N can be displayed on a display device 107A-107N by client application 105A-105N executing on the operating system of the client device 102A-102N or the client device 104. In some implementations, the virtual meeting manager 132 can determine visual items and/or visual indicators for presentation in the UI 108A-108N during a virtual meeting. A visual item can refer to a UI element that occupies a particular region in the UI and is dedicated to presenting a video stream from a respective client device. Such a video stream can depict, for example, a user of the respective client device while the user is participating in the virtual meeting (e.g., speaking, presenting, listening to other participants, watching other participants, etc., at particular moments during the virtual meeting), a physical conference or meeting room (e.g., with one or more participants present), a document or media content (e.g., video content, one or more images, etc.) being presented during the virtual meeting, etc. In some implementations, the virtual meeting manager 132 can determine UI features for presentation in the UI 108A-108N during a virtual meeting. A UI feature can refer to a UI element that occupies a particular region in the UI and is dedicated to presenting a particular notification (e.g., using a visual indicator) to a user of the respective client device 102A-102N.

As described previously, an audiovisual component of each client device can capture images and generate video data (e.g., a video feed) of the captured data of the captured images. In some implementations, the client devices 102A-102N and/or client device(s) 104 can transmit the generated video feed to virtual meeting manager 132. The audiovisual component of each client device can also capture an audio signal representing speech of a user and generate audio data (e.g., an audio file or audio feed) based on the captured audio signal. In some implementations, the client devices 102A-102N and/or client device(s) 104 can transmit the generated audio data to virtual meeting manager 132.

In some implementations, virtual meeting platform 120 and/or server 130 can be one or more computing devices computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a virtual meeting. Virtual meeting platform 120 can also include a website (e.g., a webpage) or application back-end software that can be used to enable a user to connect with other users via the virtual meeting.

It should be noted that in some other implementations, the functions of server 130 and/or virtual meeting platform 120 can be provided by a fewer number of machines. For example, in some implementations, server 130 can be integrated into a single machine, while in other implementations, server 130 can be integrated into multiple machines. In addition, in some implementations, server 130 can be integrated into virtual meeting platform 120.

In general, functions described in implementations as being performed by virtual meeting platform 120 and/or server 130 can also be performed by the client devices 102A-N and/or client device(s) 104 in other implementations, if appropriate. In addition, the functionality attributed to a particular component can be performed by different or multiple components operating together. In some implementations, the functions of notification manager 106A-106N can be performed by server 130 and/or by virtual meeting platform 120. Virtual meeting platform 120 and/or server 130 can also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting, implementations can also be generally applied to any type of telephone call, conference call, or virtual meeting between users. Implementations of the disclosure are not limited to virtual meeting platforms that provide virtual meeting tools to users.

In implementations of the disclosure, a “user” or “participant” can be represented as a single individual. However, other implementations of the disclosure encompass a “user” or “participant” being an entity controlled by a set of users and/or an automated source such as a system or platform. For example, a set of individual users federated as a community in a social network can be considered a “user. ” In another example, an automated consumer can be an automated ingestion pipeline, such as a topic channel, of the virtual meeting platform 120.

In situations in which the systems discussed here collect personal information about users, or can make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the virtual meeting platform 120 and/or server 130.

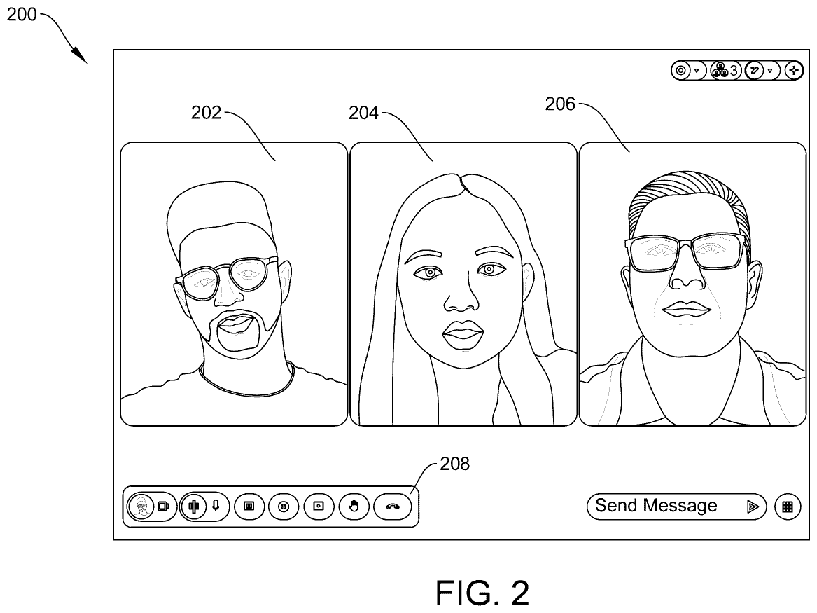

FIG. 2 illustrates an example virtual meeting UI 200 presented on a client device, in accordance with at least one embodiment of the present disclosure. In some embodiments, UI 200 can be generated by the virtual meeting manager 132 of FIG. 1 for presentation at a client device (e.g., client devices 102A-102N, 104). Accordingly, UI 200 can be generated by one or more processing devices of the server 130 of FIG. 1. As illustrated, UI 200 provides, for presentation to one or more users, a visual representation of a video stream 202 from a first client device of a first participant, a visual representation of a video stream 204 from a second client device of a second participant, and a visual representation of a video stream 206 from a third client device of a third participant. The first participant can be, for example, the user of the client device displaying UI 200. UI 200 can include tool panel 208, which can include a set of buttons to perform one or more actions related to the virtual meeting. The set of buttons can include, for example, a button to modify the video feed (e.g., turn the video feed on/off, select a background, etc.), a button to modify the audio feed (e.g., a mute button, a volume control button, an audio feed source button, etc.), a closed captions button (e.g., to turn on/off the closed captions during the virtual meeting), a emoji button (e.g., to select one or more emojis for display), a presentation button (e.g., to allow a user to present during the virtual meeting), a hand raise button, a leave button (e.g., a button to leave the virtual meeting, to end the virtual meeting, etc.), and so on. In some embodiments, the UI features presenting visual indicators of actions performed to improve the audio and/or video quality of the user device can be provided as part of the tool panel 208. The actions can improve the audio and/or video quality of the user's client device displaying UI 200. The tool panel 208 is further described with respect to FIGS. 3A-3C and FIG. 4.

FIG. 3 shows an example illustration of a waveform visual indicator 310 notifying the user that an improvement action (e.g., “reducing noise”) is being performed to improve the audio quality of the client device (e.g., of the client device displaying the UI that includes the waveform visual indicator 310), in accordance with at least one embodiment of the present disclosure. In some embodiments, the waveform visual indicator 310 can be displayed in yellow, indicating to the user that the audio quality is being improved and that no action is needed by the user. Also shown in FIG. 3 are the three waveform visual indicators 320, 322, and 324, notifying the user of the varying degrees of audio quality. In some embodiments, waveform visual indicator 320 can be displayed in green and can notify the user that the audio is of good quality (e.g., no improvement action is needed). Visual indicator 322 can be displayed in yellow and can warn the user that an improvement action is needed to improve the audio quality, and that the improvement action is automatically being performed to improve the audio quality (e.g., no action is needed by the user). Visual indicator 324 can be displayed in red and can notify the user that the audio quality is in critical condition. A red waveform visual indicator 324 can notify the user that performance of an improvement action is needed to improve the audio quality. In some embodiments, the waveform visual indicators 320-324 may not be displayed in UI 200 of FIG. 2, or may only be displayed in response to a user action or input (e.g., in response to a user hovering their mouse over a particular UI feature). That is, waveform visual indicators 320-324 can be a legend that is only sometimes displayed to the user, to avoid taking up space on the UI 200 of FIG. 2.

FIGS. 4A-4C show illustrations of examples of a tool panel that includes a UI feature displaying a visual indicator of an improvement action during a virtual meeting, in accordance with at least one embodiment of the present disclosure. The tool panel can correspond to tool panel 208 of FIG. 2. As shown in FIG. 4A, the tool panel includes an illustration of a waveform visual indicator 410 notifying the user of the user device displaying the UI that the audio is emitting an echo. In some embodiments, the waveform visual indicator 410 can be displayed in red (e.g., similar to the waveform visual indicator 324 of FIG. 3). The red color can notify the user that an improvement action has been identified and that further input is required from the user to perform the improvement action to improve the audio quality of the user device of the user.

FIG. 4B shows an illustration of a visual indicator 420 notifying the user of an input that the user can provide to cause improvement of the quality of the audio, in accordance with at least one embodiment of the present disclosure. The visual indicator 420 provides a notification to the user to use the push-to-talk-feature to reduce the echo. In some embodiments, the visual indicator 420 can be displayed in response to the user hovering their mouse over the visual indicator 410 of FIG. 4A.

FIG. 4C shows an illustration of a visual indicator 430 that presents additional information related to the improvement action, in accordance with at least one embodiment of the present disclosure. As shown, the visual indicator 430 includes the following instructions: “Press and hold the spacebar to unmute mic.” In some embodiments, the visual indicator 430 can be displayed in response to the user hovering their mouse over the visual indicator 420 of FIG. 4B.

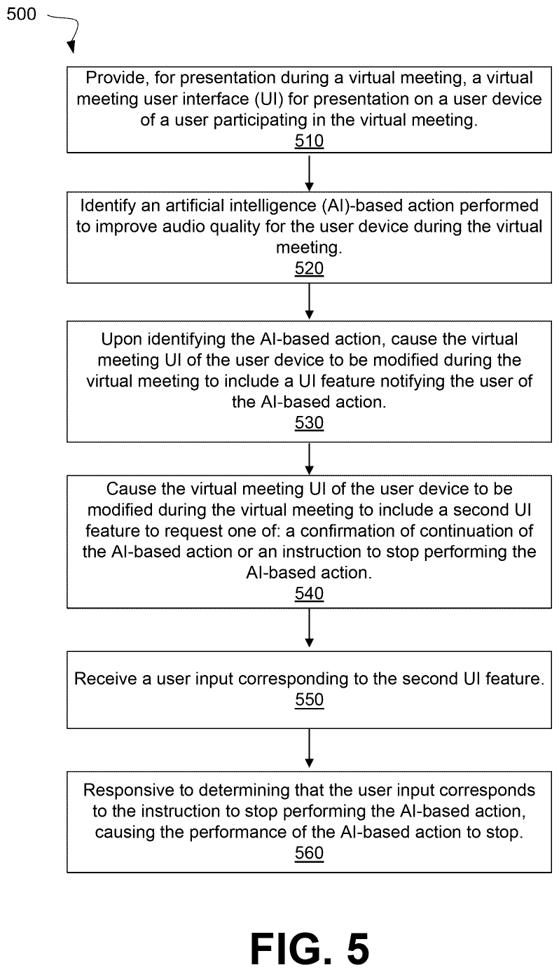

FIG. 5 is a flow diagram of an example method 500 for providing a UI feature notifying the user of an improvement action during a virtual meeting, according to at least one embodiment. Method 500 can be performed by processing logic that can include hardware (circuitry, dedicated logic, etc.), software (e.g., instructions run on a processing device), or a combination thereof. In at least one implementation, some or all of the operations of method 500 can be performed by one or more components of server device(s) 130 of FIG. 1. In other implementations, some or all of the operations of method 500 can be performed by one or more components of client devices 102A-102N, 104, and/or virtual meeting platform 120 of FIG. 1.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states, e.g., via a state diagram. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-related device or storage media.

At block 510, processing logic provides, for presentation during a virtual meeting, a virtual meeting user interface (UI) for presentation on a user device (e.g., client device 102A-102N, 104 of FIG. 1) of a user participating in a virtual meeting (e.g., the virtual meeting 122 described with respect to FIG. 1). An example UI is described with respect to FIGS. 2, 3, and 4A-4C.

At block 520, processing logic identifies an AI-based action performed to improve audio quality for the user device of the user during the virtual meeting.

In some embodiments, processing logic can provide, as input to an AI model, audio received from the user device during the virtual meeting. In some embodiments, processing logic can provide audio data corresponding to audio received from the user device (e.g., the audio received from the user device may be preprocessed to generate audio data that can be provided as input to the AI model). The AI model can be trained to output the AI-based action performed to improve the audio quality for the user device of the user during the virtual meeting. Thus, processing logic can receive, as output from the AI model, the AI-based action. In some embodiments, the AI-based action can be background noise suppression and/or echo removal, for example. The AI model is further described with respect to FIGS. 6A-6B. In some embodiments, the AI model can output a confidence score corresponding to the AI-based action. The confidence score can reflect a likelihood that the AI-based action, when performed, will improve the quality of the audio.

At block 530, upon identifying the AI-based action, processing logic causes the virtual meeting UI of the user device to be modified during the virtual meeting to include a UI feature notifying the user of the AI-based action. Examples of modifications to the virtual meeting UI are described throughout, and in particular with respect to FIGS. 3 and 4A-4C. Modifying the virtual meeting UI can include displaying a visual indicator that notifies the user of the AI-based action. As an illustrative example, processing logic can modify the color of a waveform displayed in the tool panel of the virtual meeting UI to notify the user of the AI-based action. In some embodiments, the AI-based action can be automatically performed. In some embodiments, the AI-based action can be performed in response to a user input. The AI-based action can be performed automatically if it satisfies a criterion. The criterion can be, for example, that the confidence score corresponding to the AI-based action provided by the AI model exceeds a threshold value. Additionally or alternatively, the criterion can include identifying the AI-based action on a list of actions that can be performed automatically. An example of an action that can be performed automatically can be reducing background noise or increasing the volume of the speaker, while an example of an action that is not to be performed automatically is muting the microphone or turning off the camera of the speaker.

At block 540, processing logic causes the virtual meeting UI of the user device to be modified during the virtual meeting to include a second UI feature to request one of: a confirmation of continuation of the AI-based action or an instruction to stop performing the AI-based action. That is, processing logic can provide a second UI feature that requests a user input that either confirms continuation of the AI-based action or provides an instruction to stop performing the AI-based action. In some embodiments, processing logic can cause the second UI feature to be displayed in response to a particular user input, such as the user hovering their mouse over the UI feature provided at block 530.

At block 550, processing logic receives a user input corresponding to the second UI feature. For example, the user input can correspond to the confirmation to continue the AI-based action, in which case the processing logic causes the AI-based action to continue. In some embodiments, in response to determining that the user input corresponds to the confirmation to continue the AI-based action, processing logic can take no further action. At block 560, responsive to determining that the user input corresponds to the instruction to stop performing the AI-based action, processing causes the performance of the AI-based action to stop.

In some embodiments, processing logic can determine that the AI-based action partially improved the audio quality for the user device of the user during the virtual meeting. Processing logic can identify a second action to further improve the audio quality for the user device during the virtual meeting. For example, processing logic can perform the AI-based action (either automatically or in response to a user input), and can provide the resulting improved audio to the AI model. The AI model can identify a second action to further improve the audio quality. As an illustrative example, the first AI-based action (e.g., identified at block 520) can remove background noise from the audio. The resulting, improved audio can be provided as input to the AI model, and the AI model can output an improvement action to increase the volume of the user. That is, even with the background noise removed, the voice of the user may be difficult to hear. Thus, the AI model can output a second AI-based improvement action to increase the volume of sounds on the user's client device. In some embodiments, responsive to determining that the second action satisfies a criterion, processing logic causes the second action to be performed. That is, processing logic can determine whether to automatically perform the second action. In some embodiments, the second action can be automatically performed (e.g., the criterion is satisfied) if it is on a list of actions to be automatically performed. In some embodiments, the second action can be automatically performed (e.g., the criterion is satisfied) if the confidence score corresponding to the second AI-based action provided by the AI model exceeds a threshold value. In some embodiments, processing logic causes the UI feature to notify the user of the second action. That is, processing logic can modify the UI to provide a UI feature displaying a visual indicator of the second action.

FIG. 6A illustrates a schematic block diagram for an example artificial intelligence (AI) training subsystem 600 to train one or more AI models 630A-M, in accordance with some implementations of the present disclosure. As illustrated in FIG. 6A, the AI training subsystem 600 can include a training subsystem 610, which can include a training data engine 612, a training engine 614, a validation engine 616, a selection engine 618, or a testing engine 620. The AI training subsystem 600 can include one or more AI models 630A-M.

In one implementation, an AI model 630A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN can include adjusting the weights or other features of the ANN based on an output produced by the ANN during training.

An ANN can include, for example, a convolutional neural network (CNN), recurrent neural network (RNN), or a deep neural network. A CNN, a specific type of ANN, hosts multiple layers of convolutional filters. Pooling is performed, and non-linearities can be addressed, at lower layers, on top of which a multi-layer perceptron is commonly appended, mapping top layer features extracted by the convolutional layers to decisions (e.g., classification outputs). A deep network can include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) can include a hierarchy of layers, where the different layers learn different levels of representations that correspond to different levels of abstraction. In deep learning, each level learns to transform its input data into a slightly more abstract and composite representation.

In some implementations, an AI model 630A-M is an AI model that has been trained on a corpus of data. For example, the AI model 630A-M can be an AI model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. In some implementations, this first foundational model is trained using self-supervision, or unsupervised training on such datasets.

In some implementations, the second portion of training, including fine-tuning, includes unsupervised, supervised, reinforced, or any other type of training. In some implementations, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 630A-M while training can be ranked by a user, according to a variety of factors, including accuracy, helpfulness, veracity, acceptability, or any other metric useful in the fine-tuning portion of training. In this manner, the AI model 630A-M can learn to favor these and any other factors relevant to users when generating a response. Further details regarding training are provided below.

In some implementations, an AI model 630A-M includes one or more pre-trained models, or fine-tuned models. In a non-limiting example, in some implementations, the goal of the “fine-tuning” can be accomplished with a second, or third, or any number of additional models. For example, the outputs of the pre-trained model can be input into a second AI model 630A-M that has been trained in a similar manner as the “fine-tuned” portion of training above. In such a way, two more AI models 630A-M can accomplish work similar to one model that has been pre-trained, and then fine-tuned.

In some implementations, the training subsystem 610 manages the training and testing of an AI model 630A-M. The training data engine 612 can generate training data. For example, in the present disclosure the training data can include video and/or audio content. The audio content of the training data can include audio feeds of participants participating in a virtual meeting. In some embodiments, the audio training data can include a recording of a person speaking. In some embodiments, the audio content is included in the video content. The audio data can include one or more phonemes, word fragments, words, sentences, or other portions of speech. Each piece of audio training data can include a corresponding target output that includes a quality value of the audio data of the audio training data. The quality value can represent the quality of the audio feed (e.g., whether there is an echo, whether there is background noise in the audio, whether the speaker is audible (e.g., the volume of the audio), whether the audio is muffled, whether the audio is clear, and/or other similar factors). The training engine 614 can use the audio content training data to train an AI model 630A-M configured to identify an improvement action to improve the audio feed of a user device during a virtual meeting 122. The video content can include one or more video feeds of participants participating in a virtual meeting (e.g., speaking, listening, sharing, etc.). The video content can include video content of a participant sharing documents, images, etc., during a virtual meeting. Each piece of video training data can include a target output that includes a quality value of the video data of the video training data. The quality value can represent the quality of the video feed (e.g., whether the participant is visible or centered in the frame, whether the participant is in focus or out of focus in the video feed, whether the participant is facing the camera associated with a video feed, whether the lighting is satisfactory, and/or other similar factors). The training engine 614 can use the video content training data to train an AI model 630A-M configured to identify an improvement action to improve the video feed of a user device during a virtual meeting 122.

In an illustrative example, the training data engine 612 can initialize a training set T to null (e.g., { }). The training data engine 612 can add the training data to the training set T and can determine whether training set T is sufficient for training a AI model 630A-M. The training set T can be sufficient for training the AI model 630A-M if the training set T includes a threshold amount of training data, in some implementations. In response to determining that the training set T is not sufficient for training, the training data engine 612 can identify additional data to use as training data. In response to determining that the training set T is sufficient for training, the training data engine 612 can provide the training set T to the training engine 614.

The training engine 614 can train an AI model 630A-M using the training data (e.g., training set T). The AI model 630A-M can refer to the model artifact that is created by the training engine 614 using the training data, where such training data can include training inputs and, in some implementations, corresponding target outputs. The training engine 614 can input the training data into the AI model 630A-M so that the AI model 630A-M can find patterns in the training data and configure itself based on those patterns.

Where the AI model 630A-M uses supervised learning, the training engine 614 can assist the AI model 630A-M in determining whether the AI model 630A-M maps the training input to the target output. Where the AI model 630A-M uses unsupervised learning, the training engine 614 can input the training data into the AI model 630A-M The AI model 630A-M can configure itself based on the input training data, but since the training data may not include a target output, the training engine 614 may not assist the AI model 630A-M in determining whether the AI model 630A-M provided a correct output during the training process.

The validation engine 616 can be capable of validating a trained AI model 630A-M using a corresponding set of features of a validation set from the training data engine 612. The validation engine 616 can determine an accuracy of each of the trained AI models 630A-M based on the corresponding sets of features of the validation set. Where the training data may not include a target output, validating a trained AI model 630A-M can include obtaining an output from the AI model 630A-M and providing the output to another entity for evaluation. The other entity can include another AI model 630A-M configured to evaluate the output of the AI model 630A-M that is undergoing training. The other entity can include a human. The validation engine 616 can discard a trained AI model 630A-M that has an accuracy that does not meet a threshold accuracy or that otherwise fails evaluation. In some implementations, the selection engine 618 is capable of selecting a trained AI model 630A-M that has an accuracy that meets a threshold accuracy. In some implementations, the selection engine 618 can be capable of selecting the trained AI model 630A-M that has the highest accuracy of multiple trained AI models 630A-M. In some implementations, the selection engine 618 receives input from another AI model 630A-M or a human and can select a trained AI model 630A-M based on the input.

The testing engine 620 can be capable of testing a trained AI model 630A-M using a corresponding set of features of a testing set from the training data engine 612. For example, a first trained AI model 630A that was trained using a first set of features of the training set can be tested using the first set of features of the testing set. The testing engine 620 can determine a trained AI model 630A-M that has the highest accuracy or other evaluation of all of the trained AI models 630A-M based on the testing sets.

In some implementations, the training engine 614 trains an AI model 630A. The AI model 630A can identify an improvement action that when performed, improves the audio quality of a client device (e.g., client device 102A-102N, or 104) participating in a virtual meeting (e.g., virtual meeting 122). The training data engine 612 can generate training data that includes one or more improvement actions. In some embodiments, each improvement action can have a corresponding confidence score. The confidence score can represent the likelihood that performance of the improvement action will result in an improvement of the quality of the audio of the client device. The training engine 614 can cause the AI model 630A to undergo an AI model training process using the training data. The AI model 630A can undergo a validation and testing process using the validation engine 616 and testing engine 620.

In some implementations, the training engine 614 trains an AI model 630B. The AI model 630B can identify an improvement action that when performed, improves the video quality of a client device (e.g., client device 102A-102N, or 104) participating in a virtual meeting (e.g., virtual meeting 122). The training data engine 612 can generate training data that includes one or more virtual improvement actions. In some embodiments, each improvement action can have a corresponding confidence score that represents the likelihood that performance of the improvement action will result in an improvement of the quality of video of the client device. The training engine 614 can cause the AI model 630A to undergo an AI model training process using the training data. The AI model 630A can undergo a validation and testing process using the validation engine 616 and testing engine 620.

In some implementations, the AI training subsystem 600 is part of the server 130, the platform 120, or the virtual meeting manager 132. Alternatively, the AI training subsystem 600 can be part of another server, system, sub-system, or it can be an independent system. In some implementations, the AI training subsystem 600 provides the trained one or more AI models 630A-M to the virtual meeting manager 132.

FIG. 6B illustrates a schematic block diagram for an AI inference subsystem 626 of a virtual meeting platform 120, that the action identifier 125 can use to perform one or more operations, in accordance with at least one embodiment of the present disclosure. The AI inference subsystem 626 can include one or more AI models 630A-M. The one or more AI models 630A-M can include one or more of the AI models 630A-M trained by the AI training subsystem 600, as described with respect to FIG. 6A.

In some implementations, the AI inference subsystem 626 includes an AI input/output component 640. The AI input/output component 640 can be configured to feed data as input to an AI model 630A-M, e.g., one or more video feeds received from client devices 102A-102N, 104, and/or one or more audio feeds received from client devices 102A-102N, 104. The AI input/output component 640 can be configured to obtain one or more outputs from the one or more AI models 630A-M and provide the one or more outputs to the action identifier 125. The output(s) can include improvement actions that, when performed, improve the audio and/or video quality of the corresponding client device 102A-102N, 104. In some embodiments, the output(s) have a corresponding confidence score that reflects a level of confidence that performing the action will result in an improved audio and/or video quality.

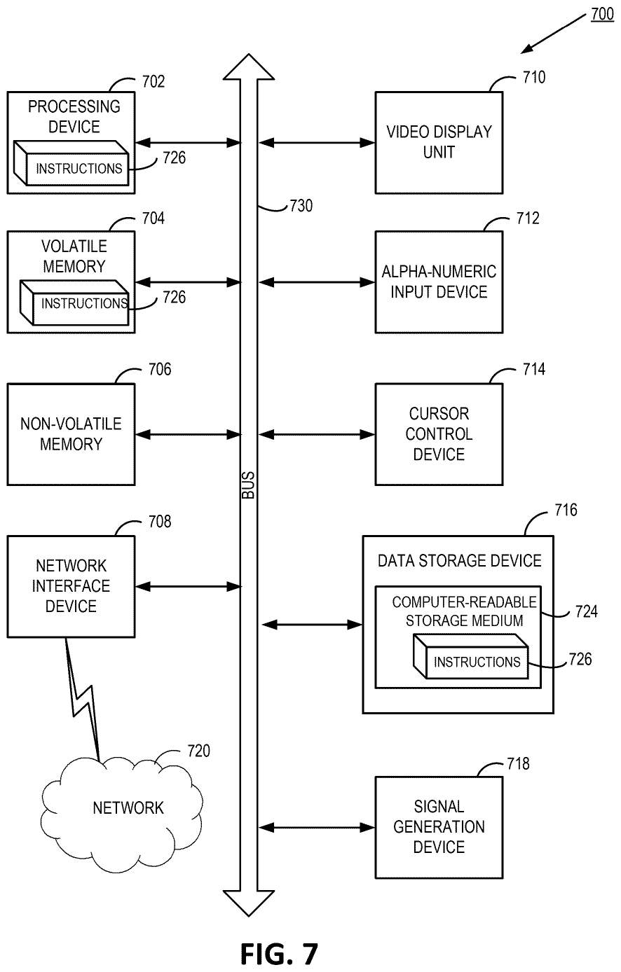

FIG. 7 is a block diagram illustrating an exemplary computer system 700, in accordance with at least one embodiment of the present disclosure. The computer system 700 can correspond to server device 130, platform 120, and/or client devices 102A-102N, 104 in FIG. 1. The machine can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., volatile memory, read-only memory (ROM), flash memory, dynamic random access memory (DRAM) such as synchronous DRAM (SDRAM), double data rate (DDR SDRAM), or DRAM (RDRAM), etc.), a static memory 706 (e.g., non-volatile memory, flash memory, static random access memory (SRAM), etc.), and a data storage device 716, which communicate with each other via a bus 730.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 726 (e.g., for providing visual indicators of improvement actions performed during a virtual meeting) for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 718 (e.g., a speaker).

The data storage device 716 can include a non-transitory machine-readable storage medium 724 (also computer-readable storage medium) on which is stored one or more sets of instructions 726 (e.g., for providing visual indicators of improvement actions performed during a virtual meeting) embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 720 via the network interface device 708.

In one implementation, the instructions 726 include instructions for providing visual indicators of improvement actions performed during a virtual meeting. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
providing, for presentation during a virtual meeting, a virtual meeting user interface (UI) for presentation on a user device of a user participating in the virtual meeting;
identifying an artificial intelligence (AI)-based action performed to improve audio quality for the user device of the user during the virtual meeting; and
upon identifying the AI-based action, causing the virtual meeting UI of the user device to be modified during the virtual meeting to include a UI feature notifying the user of the AI-based action.

2. The method of claim 1, further comprising:
causing the virtual meeting UI of the user device to be modified during the virtual meeting to include a second UI feature to request one of: a confirmation of continuation of the AI-based action or an instruction to stop performing the AI-based action;
receiving a user input corresponding to the second UI feature; and
responsive to determining that the user input corresponds to the instruction to stop performing the AI-based action, causing the performance AI-based action to stop.

3. The method of claim 1, further comprising:
determining that the AI-based action partially improved the audio quality for the user device of the user during the virtual meeting; and
identifying a second action to further improve the audio quality for the user device during the virtual meeting.

4. The method of claim 3, further comprising:
responsive to determining that the second action satisfies a criterion, causing the second action to be performed.

5. The method of claim 3, further comprising:
causing the UI feature to notify the user of the second action.

6. The method of claim 1, further comprising:
providing, as input to an AI model, audio received from the user device during the virtual meeting, wherein the AI model is trained to output the AI-based action performed to improve the audio quality for the user device of the user during the virtual meeting; and
receiving, as output from the AI model, the AI-based action.

7. The method of claim 1, wherein the AI-based action comprises at least one of:
background noise suppression or echo removal.

8. A system comprising:
a memory device; and
a processing device coupled to the memory device, the processing device to perform operations comprising:
providing, for presentation during a virtual meeting, a virtual meeting user interface (UI) for presentation on a user device of a user participating in the virtual meeting;
identifying an artificial intelligence (AI)-based action performed to improve audio quality for the user device of the user during the virtual meeting; and
upon identifying the AI-based action, causing the virtual meeting UI of the user device to be modified during the virtual meeting to include a UI feature notifying the user of the AI-based action.

9. The system of claim 8, further comprising:
causing the virtual meeting UI of the user device to be modified during the virtual meeting to include a second UI feature to request one of: a confirmation of continuation of the AI-based action or an instruction to stop performing the AI-based action;
receiving a user input corresponding to the second UI feature; and
responsive to determining that the user input corresponds to the instruction to stop performing the AI-based action, causing the performance AI-based action to stop.

10. The system of claim 8, further comprising:
determining that the AI-based action partially improved the audio quality for the user device of the user during the virtual meeting; and
identifying a second action to further improve the audio quality for the user device during the virtual meeting.

11. The system of claim 10, further comprising:
responsive to determining that the second action satisfies a criterion, causing the second action to be performed.

12. The system of claim 10, further comprising:
causing the UI feature to notify the user of the second action.

13. The system of claim 8, further comprising:
providing, as input to an AI model, audio received from the user device during the virtual meeting, wherein the AI model is trained to output the AI-based action performed to improve the audio quality for the user device of the user during the virtual meeting; and
receiving, as output from the AI model, the AI-based action.

14. A non-transitory computer readable storage medium comprising instructions for a server that, when executed by a processing device, cause the processing device to perform operations comprising:
providing, for presentation during a virtual meeting, a virtual meeting user interface (UI) for presentation on a user device of a user participating in the virtual meeting;
identifying an artificial intelligence (AI)-based action performed to improve audio quality for the user device of the user during the virtual meeting; and
upon identifying the AI-based action, causing the virtual meeting UI of the user device to be modified during the virtual meeting to include a UI feature notifying the user of the AI-based action.

15. The non-transitory computer readable storage medium of claim 14, further comprising:
causing the virtual meeting UI of the user device to be modified during the virtual meeting to include a second UI feature to request one of: a confirmation of continuation of the AI-based action or an instruction to stop performing the AI-based action;
receiving a user input corresponding to the second UI feature; and
responsive to determining that the user input corresponds to the instruction to stop performing the AI-based action, causing the performance AI-based action to stop.

16. The non-transitory computer readable storage medium of claim 14, further comprising:
determining that the AI-based action partially improved the audio quality for the user device of the user during the virtual meeting; and
identifying a second action to further improve the audio quality for the user device during the virtual meeting.

17. The non-transitory computer readable storage medium of claim 16, further comprising:
responsive to determining that the second action satisfies a criterion, causing the second action to be performed.

18. The non-transitory computer readable storage medium of claim 16, further comprising:
causing the UI feature to notify the user of the second action.

19. The non-transitory computer readable storage medium of claim 14, further comprising:
providing, as input to an AI model, audio received from the user device during the virtual meeting, wherein the AI model is trained to output the AI-based action performed to improve the audio quality for the user device of the user during the virtual meeting; and
receiving, as output from the AI model, the AI-based action.

20. The non-transitory computer readable storage medium of claim 14, wherein the AI-based action comprises at least one of: background noise suppression or echo removal.
